(19) United States
(12) Patent Application Publication
(10) Pub. No.: US 2007/0022096 A1
(43) Pub. Date: Jan. 25, 2007

(54) Method and system for searching a plurality of web sites

(75) Inventor: Matthew Hertz, Hod Hasharon (IL)

Correspondence Address: DR. MARK FRIEDMAN LTD.;c/o Bill Polkinghorn, 9003 Florin Way, Upper Marlboro, MD, 20772, US

(73) Assignee: POOGEE SOFTWARE LTD.

(21) Appl. No.: 11/186,945

(22) Filed: Jul. 22, 2005

(51) Int. Cl. G06F 17/30

(52) U.S. Cl. 707/3

(57) ABSTRACT

A method, system, and computer readable code for searching a plurality of web sites. Each web site provides a user search interface array including at least one user search interface for accessing text documents, each text document provided by the web sites includes a document body and optional labeling text, and A database is maintained including at least a partial representation of the respective user search interface array for each web site. At least one user search query associated with a plurality of search terms is received, and for each web site, a formulated search query is derived from the respective representation and from the user search query. According to some embodiments, the formulated query encodes directives to search the web site such that each received search term matches a value of a different respective text field of the text documents. A plurality of formulated search queries are broadcast to a plurality of web sites and search results of the broadcast queries are received. In some embodiments, each search term is associated with a different respective text field type.

### FIELD OF THE INVENTION

The present invention relates to systems and methods for effecting a search of a plurality of web sites.

### BACKGROUND OF THE INVENTION

On-line search engines such as those provided by Google and Yahoo are widely used for locating and accessing content over the Internet. One salient feature of online search engines is that they provide a single user search interface for accessing material gathered from a plurality of web sites, thereby obviating the need for individual users to access a listing of this material directly from each respective web site. This saves a great deal of time and allows users to view a single set of search results obtained from the different web sites. To date, Google claims to provide search results from over 8 billion web pages. Although this represents an enormous amount of searchable information, users of these search engines must nevertheless satisfy themselves with partial results due to the inability of search engine providers to download and index all information accessible to individual users.

Search engine providers automated the process of downloading or accessing web pages by using web crawlers or “spiders” that crawl or navigate the web by following explicit links between web pages. Although these spiders effectively reach web pages specifically referenced by these explicit links, many publicly available web pages are only accessible at URLs or addresses that are not explicitly archived in any web page accessible to the spiders, and consequently, these pages remain beyond the reach of standard web crawlers or spiders.

For example, there is an entire corpus of material that users may access by entering one or more specific search terms or queries from users into a “web form.” In many cases, information embedded within these web forms such as form field names and default values for form fields is combined with the search terms or queries received from the user to generate an appropriate HTTP request that uniquely invokes the desired page to be provided by the web site. Upon receiving this HTTP request, which can include information in a generated URL (form type of GET) and/or additional content (form type of POST), the relevant web site provides the desired page, often by dynamically generating the actual page only upon receiving the user's request.

Unfortunately, these cybernetic spiders or web crawlers are not endowed with human intelligence and cannot anticipate every possible appropriate web form input operative to retrieve documents provided by the web site. As such, many documents remain invisible to the indexing search engines.

Thus, many users are unable to benefit from a single search interface for searching and retrieving this material that is inaccessible to search engines' web crawlers or spiders. There is an ongoing need for tools for searching and retrieving a more complete set of publicly available documents over a wide area network.

One disclosed method of searching the Internet, disclosed by companies like Copernic (Copemic Technologies, Inc. 360, rue Franquet #60, Sainte-Foy, Quebec, Canada) in descriptions of their “CopernicAgent” product and CiteLine (1608 Merlot Ct., Petaluma, Calif., USA) described in U.S. Pat. No. 6,766,315 is to broadcast a single search query to a plurality web sites including what is disclosed in U.S. Pat. No. 6,766,315 as “hidden web databases.”

Although U.S. Pat. No. 6,766,315 discloses the simultaneous search of multiple online databases by broadcasting search keywords to many sites, the disclosed method is of limited utility for a number of important applications. Many web sites have one or more structured user search interfaces which require that search terms are received in a specific manner. In one example, a user is searching for a specific person named John Smith having an address in Houston, Tex. using an online telephone directory such as that available from www.switchboard.com, which provides specific search fields for first name, last name, city, and state. If, for example, one were to send this web site the search terms {“John Smith”,“Houston”,“Texas”}, the system would be unable to provide an appropriate search result, because this multiword query lacks the semantic information that “John” is a first name, “Smith” is a last name, “Houston” is a city, and “Texas” is a state. Thus, presently available tools are unable to broadcast these types of queries, and users are once more deprived of an efficient search interface for searching and accessing material not explicitly linked to by other web pages.

### SUMMARY OF THE INVENTION

The aforementioned needs are satisfied by several aspects of the present invention.

It is now disclosed for the first time a method of searching web sites, each web site providing a user search interface array including at least one user search interface for accessing text documents, each text document including a document body and optional labeling text. The presently disclosed method includes maintaining a database including at least a partial representation of the respective user search interface array for each web site, receiving at least one user search query associated with a plurality of search terms, for each web site, deriving from the respective representation and from the received user search query a formulated search query, encoding directives to search the web site such that each search term matches a value of a different respective text field of the text documents, broadcasting a plurality of the formulated search queries to a plurality of web sites, and receiving search results of the broadcast queries directly or indirectly from the web site.

According to some embodiments, at least one formulated query encodes a directive to search at least one web site such that each received search term matches a value of a different respective text field within the document body of the text documents.

According to some embodiments, the receiving of the search results includes receiving at least one identifier for accessing a respective text document, and the method further includes presenting to a user a menu of at least one identifier. Exemplary “identifiers for accessing” include but are not limited to hyperlinks.

According to some embodiments, the receiving of the search results includes receiving at least one text document satisfying search criteria of a formulated query from at least one web site.

According to some embodiments, each search term is associated with a different respective text field type.

According to some embodiments, the receiving of the plurality of search terms includes receiving a string and identifying with the string a plurality of search terms, were each the search term is associated with a different text field type.

According to some embodiments, the receiving of the user search query includes presenting a user search field interface for receiving and/or presenting a plurality of the text field type identifiers.

According to some embodiments, the user search field interface is configured for selecting a text field type identifiers from a plurality of text field type identifiers.

According to some embodiments, the formulated query encodes a directive to search the web site such that each respective search term matches a value of a text field having a type that is semantically equivalent to the text field type associated with the respective search term.

According to some embodiments, for at least one web site, or for a plurality of web sites, the formulated search query is substantially identical to a query generatable using a user search interface of the web site. Thus, embodiments of the present invention provide for automatically formulated search queries, broadcast to a plurality of web sites, where each broadcast emulates the query generated by the user search interface to access the respective web site.

According to some embodiments, the matching of the value of text field is selected from the group consisting of exact match, regular expression match, a synonym match, an approximate string match, a mapping match, a prefix match.

According to some embodiments, the formulated queries are sent substantially simultaneously.

According to some embodiments, a single user search query is received, and at least two formulated queries are derived from the received single user search query.

According to some embodiments, the single user search query is received via a single interface for the plurality of web sites.

According to some embodiments, at least one user search query is received through a web interface.

According to some embodiments, the presently disclosed method further comprises presenting the search results as a webpage.

According to some embodiments, the maintaining of the database includes the steps of providing a predetermined list of desired search fields, accessing a plurality of user search interfaces associated with a plurality of candidate web sites, and adding a representation of the accessed search interface to the database if the accessed user search interface provides access to a web site with at least one desired search field.

According to some embodiments, the maintaining of the database includes parsing a plurality of web forms.

According to some embodiments, the maintaining of the database includes accessing a plurality of user search interfaces associated with a plurality of candidate web sites, extracting from the accessed user search interface at least one data item selected from the group consisting of a target URL, an access method type, a search field name, default search field data, a field type parameter of a search field, a textual description of a search field, and a requirement status of a field.

According to some embodiments, the maintaining of the database includes identification of a semantic meaning of a field of a search interface for at least one web site.

According to some embodiments, the deriving of a formulated query includes determining a signature of a received search query, and for a first web site a first formulated query is created according to a first subsignature of the received search query signature, and for a web site a second formulated query is created according to a second subsignature of the received search query signature, wherein the first subsignature differs from the second subsignature.

According to some embodiments, the first subsignature differs from the second subsignature according to syntactic properties.

According to some embodiments, the first subsignature includes a first number of search fields, the second subsignature includes a second number of fields, and the first number differs from the second number.

According to some embodiments, the first subsignature differs from the second subsignature according to semantic properties.

According to some embodiments, for at least one web site the representation includes a representation of a plurality of search interfaces, and the deriving of the formulated query includes selecting a search interface appropriate for the received search query from the representation of the plurality of search interfaces.

According to some embodiments, the selecting includes locating a user search interface from the plurality of user search interfaces with a signature that best matches a signature of the received search query.

According to some embodiments, the best match is an exact match of the received search query.

According to some embodiments, the best match is a maximal sub-signature of the received search query.

According to some embodiments, the selecting of the appropriate search interface includes analyzing at least one signature parameter selected from the group consisting of a syntactic property of a signature, a semantic property of a signature and a number of fields in a signature.

According to some embodiments, the stage of sending a plurality of formulated queries includes generating at least one HTTP request

According to exemplary embodiments, a text field is of a type that is semantically equivalent to a text field selected from the group, consisting of a proper name, first name, a state, a company, a country, a city, and a family name.

It is now disclosed for the first time a system for searching web sites, each web site providing a search interface array including at least one user search interface for accessing text documents, each text document including a document body and optional labeling text. The presently disclosed system includes a database including at least a partial representation of the respective user search interface array for each web site, a search query input for receiving at least one user search query associated with a plurality of search terms, a formulated query creator for deriving from the respective representation and from the user search query a formulated search query encoding directives to search the web site such that each search term matches a value of a different respective text field of the text documents, a formulated query dispatcher for broadcasting a plurality of the formulated search queries to a plurality of web sites and a search results receiver for receiving search results of the broadcast queries.

According to some embodiments, the formulated query dispatcher is operative to substantially simultaneously send the formulated queries to the respective web sites.

According to some embodiments, the presently disclosed system further includes a signature analyzer, for analyzing at least one signature selected from the group consisting of a signature of the received user search query and at least one user search interface selected from the user search interface array of a web site, wherein the formulated query creator is operative to create at least one formulated query in accordance with results of the signature analysis.

According to some embodiments, at least one description of the respective search interface array includes, for at least one web site, a description of a plurality of user search interfaces, and the system further includes a search interface selector for selecting an appropriate user search interface from the plurality of search interfaces.

According to some embodiments, the system further includes a signature analyzer, for analyzing at least one signature of a user search interface among the plurality of search interfaces, and the selection of the appropriate search interface is effected in accordance with results from the signature analysis.

According to some embodiments, the system further includes at least one interface for providing access to the received search results.

It is now disclosed for the first time computer readable storage medium having computer readable code embodied in the computer readable storage medium, the computer readable code for searching web sites, each web site providing a publicly available search interface array including at least one user search interface for accessing text documents, each text document including a document body and optional labeling text, the computer code including instructions to maintain a database including at least a partial representation of the respective user search interface array for each web site, receive at least one user search query associated with a plurality of search terms, for each web site, derive from the respective representation and from the received user search query a formulated search query encoding directives to search the web site such that each search term matches a value of a different respective text field of the text documents, broadcasting a plurality of the formulated search queries to a plurality of web sites, and receive search results of the broadcast queries directly or indirectly from the web site.

These and further embodiments will be apparent from the detailed description and examples that follow.

### BRIEF DESCRIPTION OF THE DRAWINGS

FIGS. 1-3 provide images of exemplary prior art user search interfaces.

FIG. 4 provides a schematic of an exemplary system for populating a database with representations of a plurality of web sites according to some embodiments of the present invention.

FIGS. 5 and 6 provide marked up source listing of HTML web forms where each web form provides at least one user search interface to an web site.

FIG. 7 provides some exemplary database entries from an exemplary User Search Interface Database according to some embodiments of the present invention.

FIG. 8 provides a schematic diagram of an exemplary system for broadcasting structured queries.

FIGS. 9-10 provides an image of an exemplary interface for receiving user search queries to be broadcast to a plurality of web sites.

FIG. 11 provides an image of an exemplary interface for receiving search results.

### DETAILED DESCRIPTION OF THE INVENTION

The present invention will now be described in terms of specific, example embodiments. It is to be understood that the invention is not limited to the example embodiments disclosed. It should also be understood that not every feature of the methods, apparatus and computer readable code for searching web sites described is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

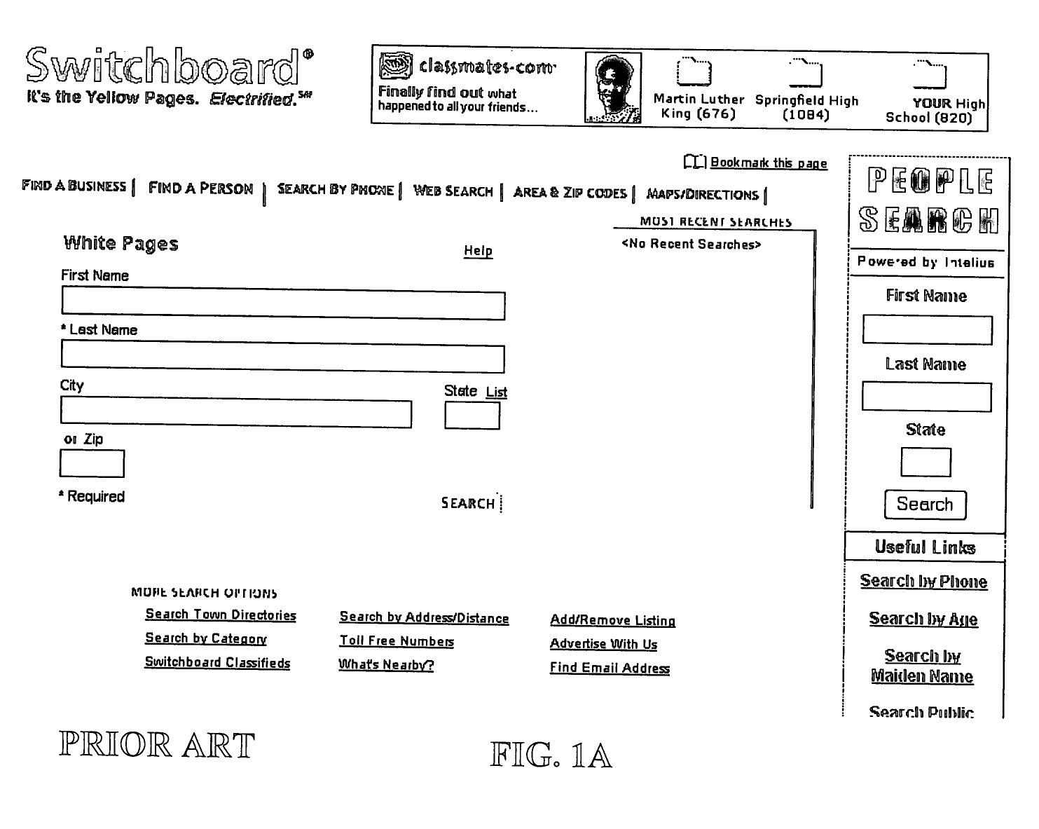

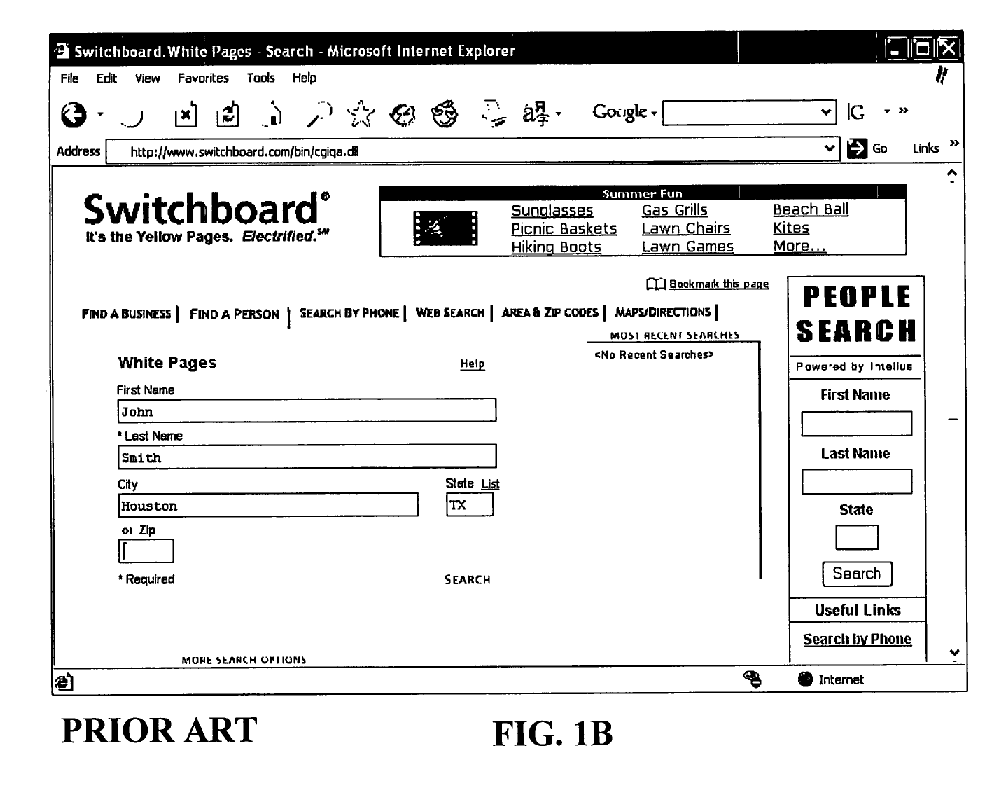

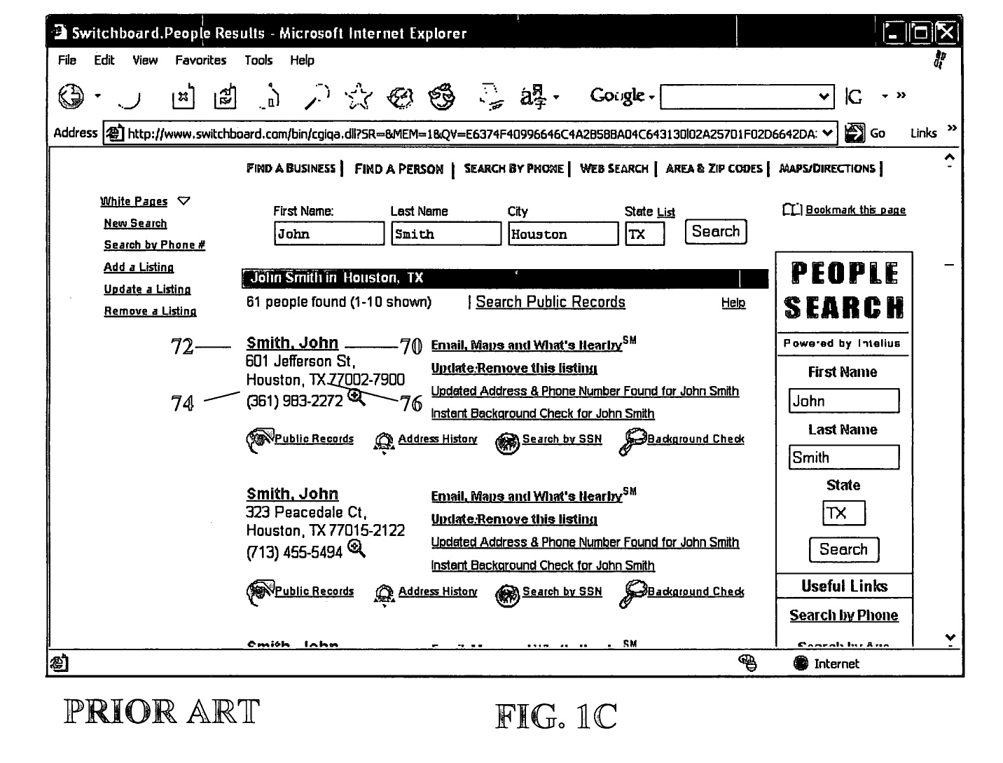

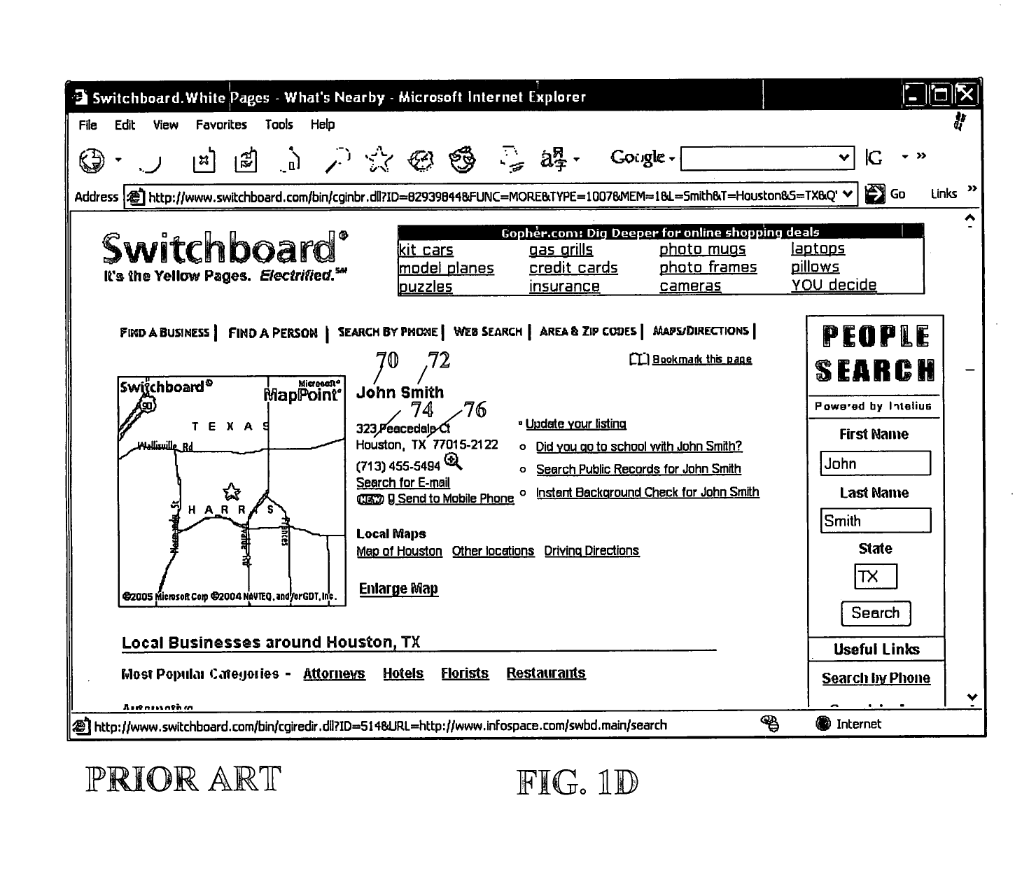

FIG. 1 provides a screen shot of an exemplary user interface array including a plurality of user search interfaces for accessing text documents from a website. It is noted that the user search interface array is publicly available over the Internet. The search query formulated by the user search interface (e.g. HTML form) encodes a directive to search the web site such that each respective search term matches a value of a text field having a type that is semantically equivalent to the text field type associated with the respective search term.

The various search interfaces from the user search interface array of FIG. 1 are used to access text documents containing text organized into a plurality of text fields. In the Example of FIG. 1, a user can query the Switchboard® interface in order to locate persons according to a variety of text fields, each text field having a text field type with a specific semantic meaning. The text fields types provided in FIG. 1A include First Name, Last Name, City, State and Zip Code.

It is noted that the interface of FIG. 1A provides more than one way of searching the web site for text documents using more than one text field. As illustrated in FIG. 1A, the only search field required is “Last Name”, and thus various combinations are valid. For the example of FIG. 1A, exemplary user search interfaces include (among others): {First Name, Last Name, Zip Code}, {First Name, Last Name, City, State}, {Last Name, Zip Code}, etc. As used herein, a “user search interface array” includes one or more user search interfaces.

The user enters specific values for the text fields or search fields. In the specific example of FIG. 1B, the value for the search or text field having a text field type with the semantic meaning “First Name” is “John”, the value for the search or text field having a text field type with the semantic meaning “Last Name” is “Smith”, the value for the search or text field having a text field type with the semantic meaning “City” is “Houston”, the value for the search or text field having a text field type with the semantic meaning “State” is “TX.” It is noted that for the specific example of FIG. 1B, the use search interface among the user search interface array invoked has a signature “First Name”, “Last Name”, “Houston”, “TX.” The signature is a list of text field types and in this specific case, the order of text field types is non-limiting.

According to the specific example described in FIG. 1, upon entering the plurality of search terms, the user's browser is operative to formulate a search query encoding a directive to search the web site (in this case the web site of Switchboard® for a specific text documents such that each search term matches a value of a different respective text field of the text document. It will be appreciated that the specific browser implementation of the user search interface depicted in FIG. 1B is not to be construed as a limitation of the user search interfaces related to the present invention.

FIG. 1C provides a screen shot of exemplary search results returned by the Switchboard® web site. FIG. 1C provides a menu of search results, wherein each search result satisfies the criteria of the query sent to the website. The HTML document displayed in the browser includes text organized into a plurality of text fields. Exemplary text fields types illustrated in FIG. 1C include the First Name 70, the Last Name 72, the city 74, and the state 76. The values of these text fields as illustrated in FIG. 1C are “John”, “Smith”, “Houston”, and “Texas.”

It is noted that FIG. 1C provides a menu of search results, and a specific search result may be selected and displayed FIG. 1D. It is noted that search result documents of both FIG. 1C and 1D include both a document body (displayed within the browser) and optional labeling text. Examples of labeling text include the title (shown at the top—for the case of FIG. 1C “Switchboard. People Results” and for the case of ID “Switchboard. White Pages—What's Nearby.” Nevertheless, the search directive encoded in FIG. 1B is operative to search the web site such that search term matches a value of a different respective text field within the document body.

It is noted that for the user search interfaces each search term is associated with a different respective text field type. In the case of the query of FIG. 1B, the term “John” was associated with the text field type semantically equivalent to “First Name”; the term “Smith” was associated with the text field type semantically equivalent to “Last Name”; the term “Houston” was associated with the text field type semantically equivalent to “City”; the term “TX” which is mapped to the state “Texas” was associated with the text field type semantically equivalent to “State”.

As used herein, two text field types or labels for text field types are “semantically equivalent” when they encompass the substantially same semantic meaning, even if literally they are only synonyms or even approximate synonyms. For example, the term “Last Name” is semantically equivalent with itself, and also semantically equivalent with “Family Name” and “Surname.” Similarly, for web sites for searching people by their religion, then “Religion” and “Faith” are semantically equivalent terms for text field types.

Because each search term is associated with a different respective text field type, changing which term is associated with which text field type within the search interface causes the user search interface or HTML form to generate a different search query encoding different search directives that is sent to the web site. It is noted in changing the text field type with which one or more search terms is associated can dramatically change the search query, even for the specific case wherein the actual text of each search term is preserved.

An example of preserving the search terms but changing which respective text field type is associated with which search term is illustrated in FIG. 1E. FIG 1F provides a screen shot of search results returned from the web site in accordance with the query of FIG. 1E. Comparison between FIG. 1C and FIG. 1F shows for the case wherein the first name is “John” and the last name is “Smith” yields 61 results, while the case wherein the first name is “Smith” and the last name “John” yields absolutely no results.

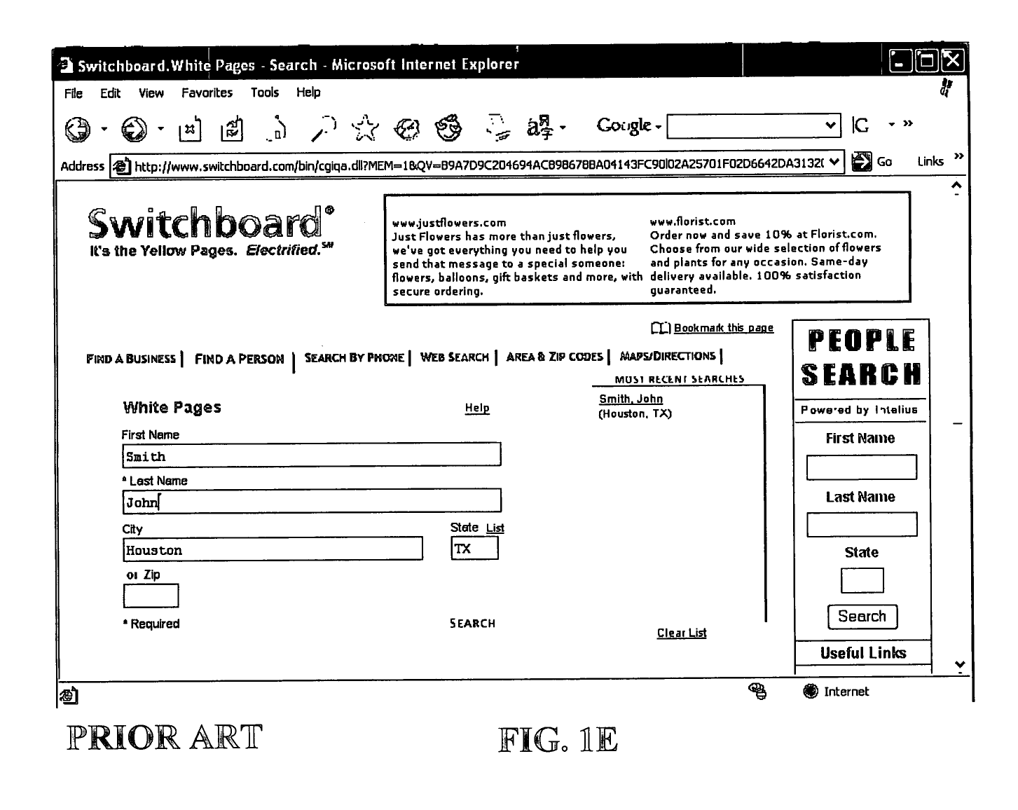

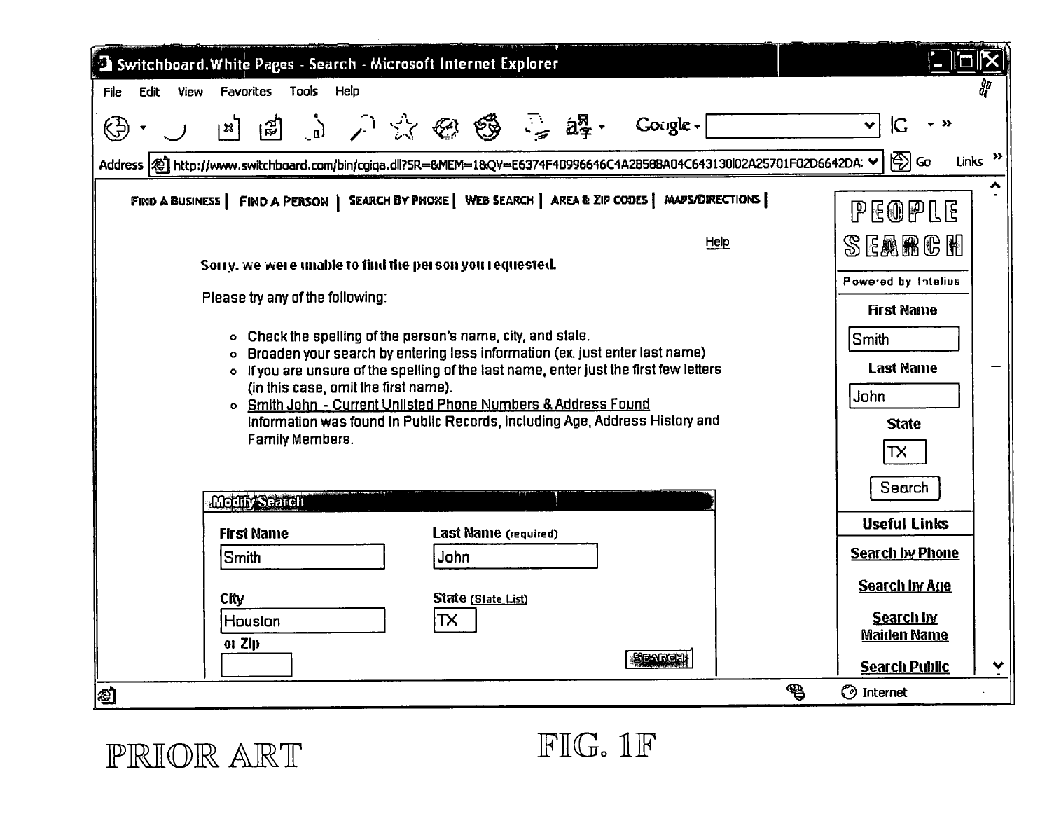

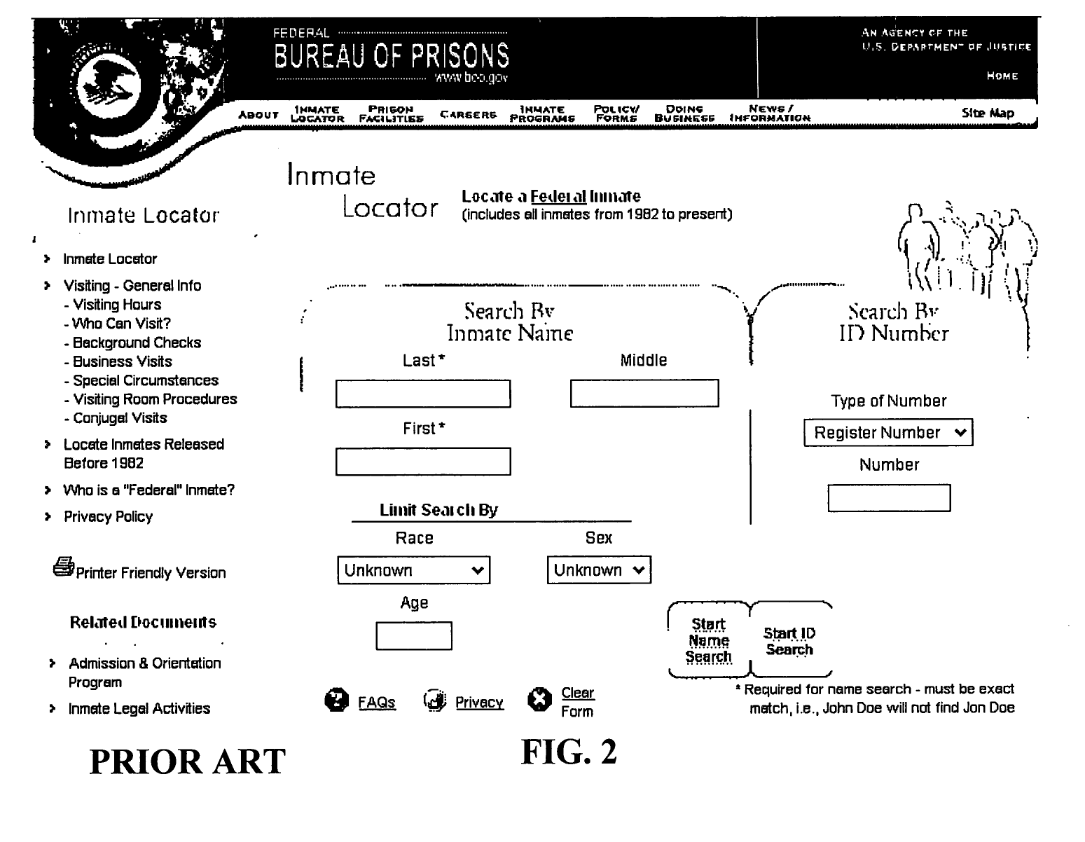

FIG. 2 provides an image of another user search interface array to another web site, namely the “Federal Bureau of Prisons” website. Text field types of the various search interfaces include “Last Name”, “Middle Name”, “First Name,” “Race,” “Sex” and “Age.”

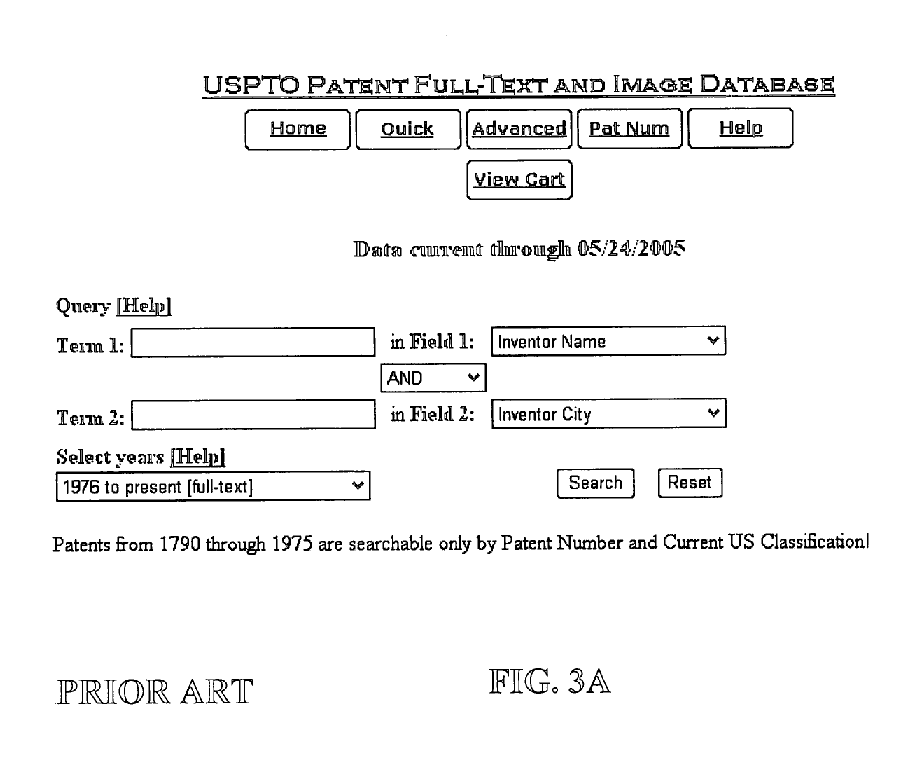

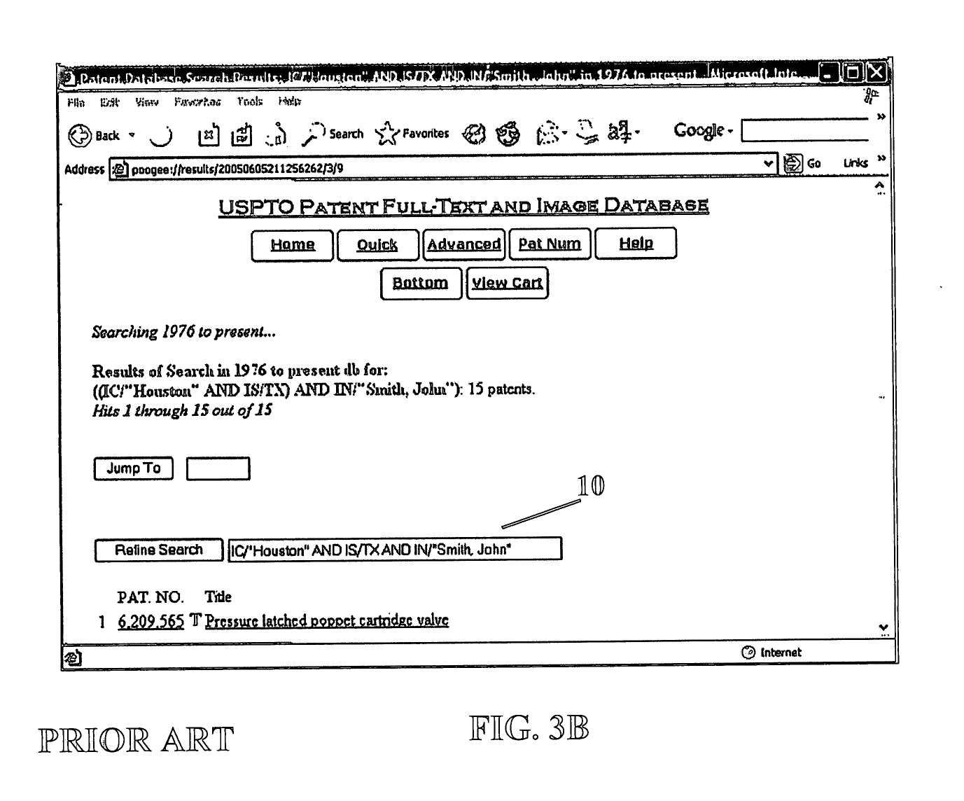

FIG. 3A provides an image of a user search interface of the USPTO patent website. As shown in FIG. 3A, the user enters two terms and can select the field type for search term. As shown in FIG. 3A, the field type of the first term is “Inventor Name” and the field type of the second term is “Inventor City.”

FIG. 3B, and in particular the text box label 10, illustrates a user search interface array where a plurality of search terms, each search term associated with a different text field type, are identified within a string received in the text box label 10. Thus, the illustrated interface is operative to derive from the single string received in the text box 10 the appropriate field types as well as the plurality of search terms, each search associated with an identified field type.

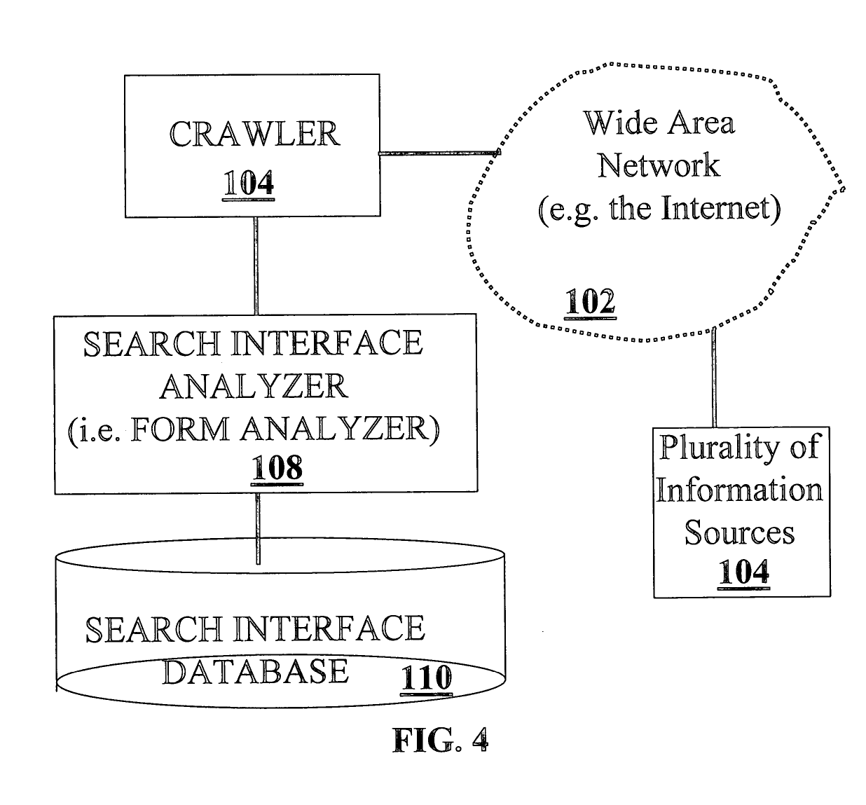

FIG. 4 provides a schematic of an exemplary system for populating a database 102 with representations of a plurality of web sites 104. As illustrated in FIG.4, a web crawler 104 or spider accesses or downloads user search interfaces from a plurality of web sites 104. One exemplary user search interface is a web form. Exemplary web forms include but are not limited to HTML and XSL forms.

Once downloaded by the crawler 104, the web forms are analyzed by a form analyzer, and based upon this analysis, a representation of at least a part of at least one user search interface for each web site 104 is stored in the database 102.

There are no specific limitations on the content accessed by the crawler 104. In certain exemplary embodiments, the crawler 104 search for forms with one or more of the following characteristics: the word “Search” in the page title or in another prominent place in the page; and forms with field descriptions matching a “hot list” of search terms like company-name, first-name, last-name, city etc. (Field description).

In some embodiments, when the crawler 104 locates a possibly appropriate form which includes one or more user search interfaces, specifics attributes of the form are analyzed by the search interface analyzer 108. Although the present invention is by no means limited to HTML forms, it is noted that for the specific example of HTML forms, exemplary characteristics analyzed include but are not limited to the form's target URL (action), the form's method (post/get/head), field names and data (if the fields are of types e.g. hidden, text, select), field description (the text following, preceding or in visual proximity to the input field) and field requirement status (asterisk, the words “required” or “optional” in close proximity to the description).

It is noted that some web sites provide more than one user search interface, and in some embodiments, a representation of more than one user search interface is entered into the database. For example, a directory web site could provide the following user search interfaces (among others): {First Name, Last Name, Zip Code}, {First Name, Last Name, City, State}, {Last Name, Zip Code}, etc. Thus, if any of these sets of parameters are sent to the web site, the web site returns the appropriate text document or set of text documents.

Another example is the “US Patent Full-Text Database Boolean Search” currently available at http://patft.uspto.gov/netahtml/search-bool.html where available search fields include: Issue Date, Patent Number, Application Date, Application Serial Number, Application Type, Assignee Name, Assignee City, Assignee State, Assignee Country, International Classification, Current US Classification, Primary Examiner, Assistant Examiner, Inventor Name, Inventor City, Inventor State, Inventor Country, Government Interest, Attorney or Agent, PCT Information, Foreign Priority, Reissue Data, Related US App. Data, Referenced By Foreign References, Other References, (s), Description/Specification. Thus, the Web site “US Patent Full-Text Database Boolean Search,” having a base URL or base address of http://patft.uspto.gov/ or http://www.uspto.gov/, provides text documents upon receiving a search query with one or more search terms (each search term including one or more words), where each search term is associated with one of the aforementioned search fields. It is noted that in this particular example and for certain web sites, user search interfaces from the “at least one user search interface” are available by selecting a combination of at least two of the listed search fields, wherein each combination of search fields functions as a user search interface.

Thus, it will be appreciated that in some embodiments, “maintaining a representation of at least one user search interface for each web site” does not require explicitly storing a text representation of every user search interface (in the above example, a text representation of actual combinations), but it suffices to store enough data to allow re-creation of a representation the user search interfaces.

It is noted that the system of FIG. 4 including the crawler 104 describes just one exemplary technique for populating the User Search Interface Database 110 and in no way should be construed as a limitation of the present invention. Thus, in some embodiments, the appropriate representation of user search interfaces for one or more web sites is obtained using methods other than crawlers. In one embodiment, this information is obtained manually without any use of a crawler.

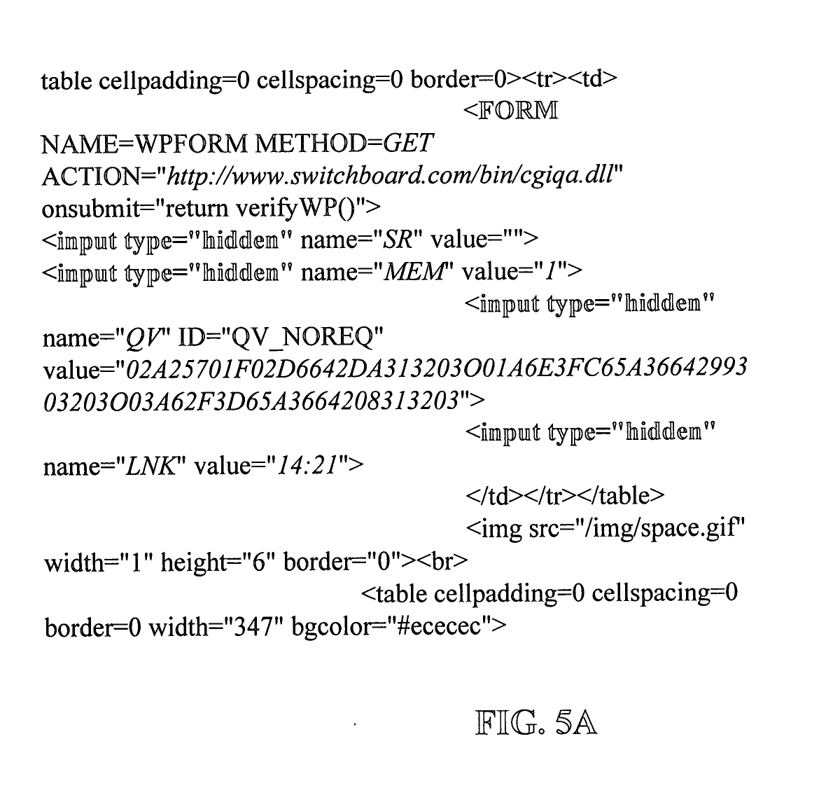

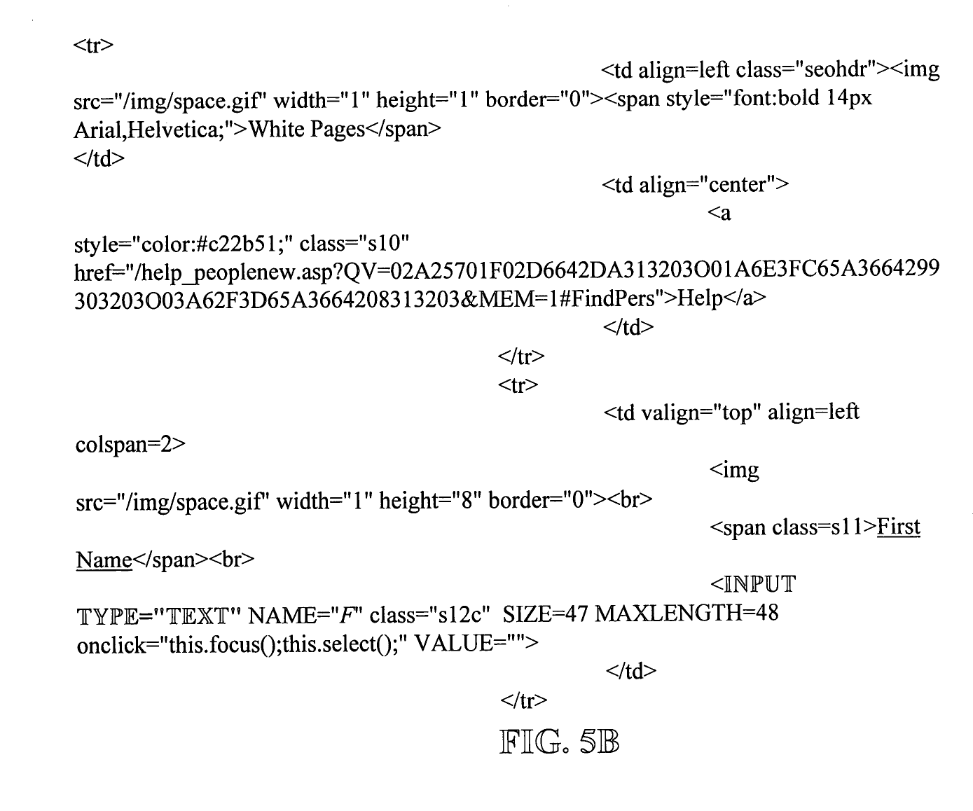

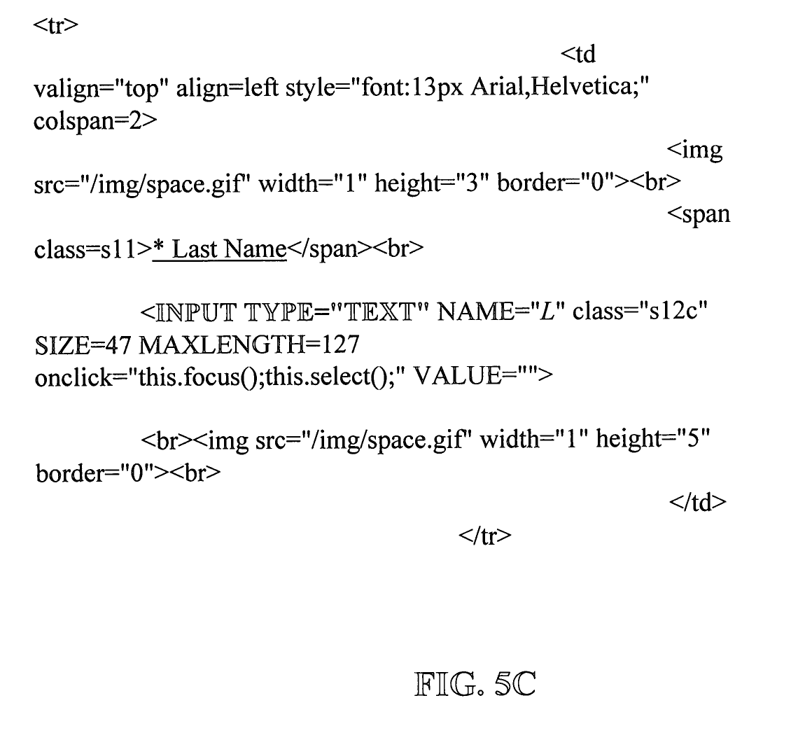

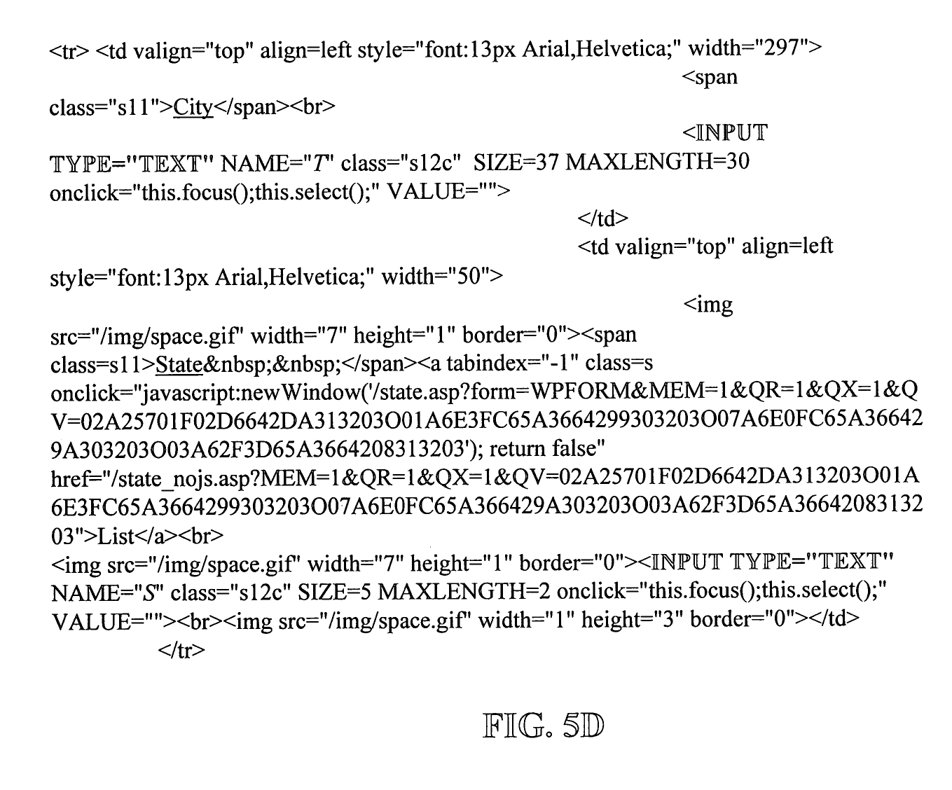

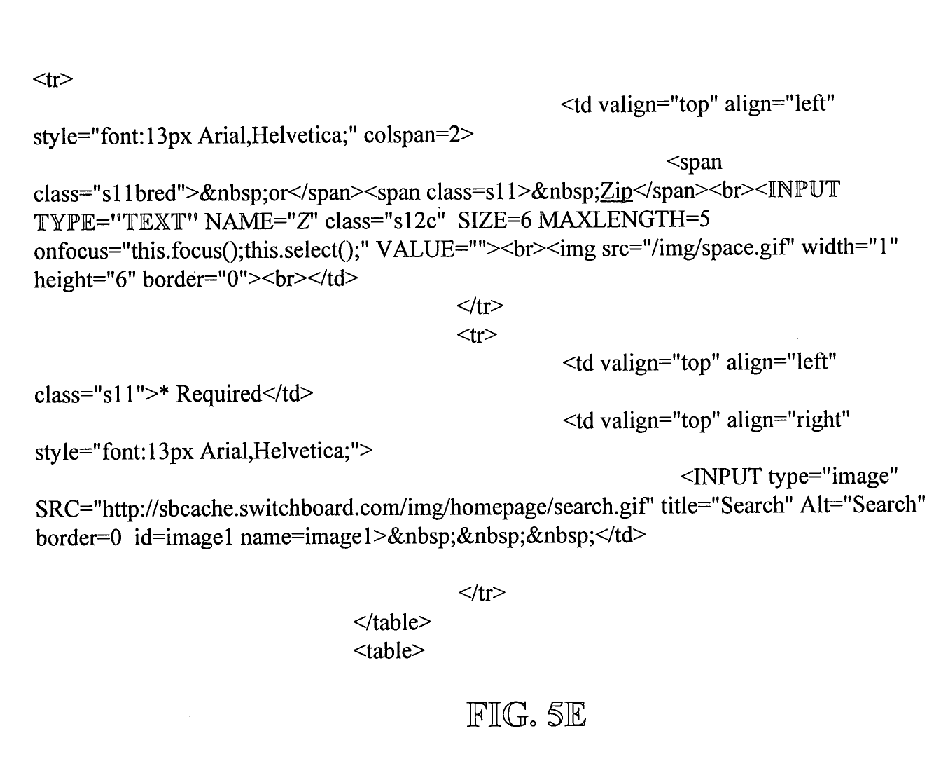

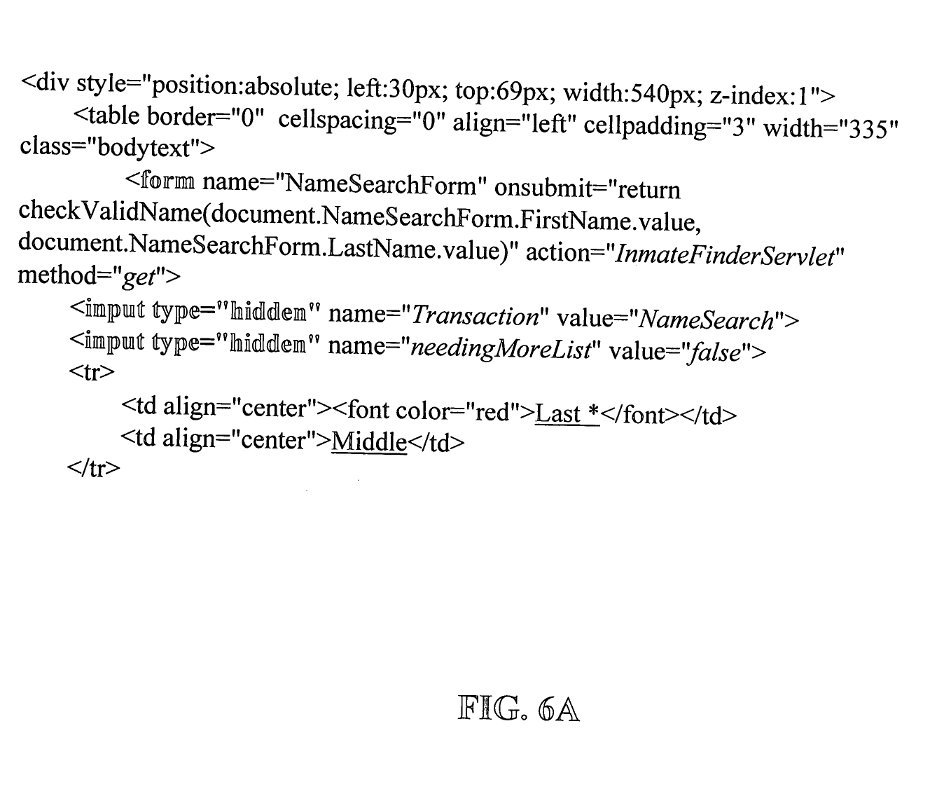

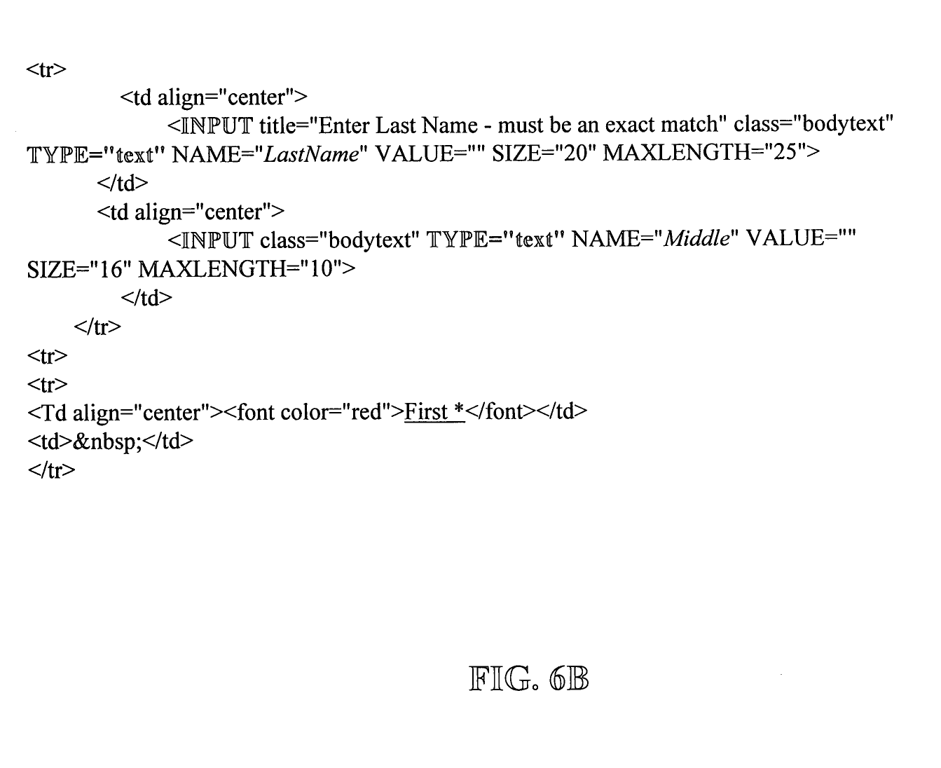

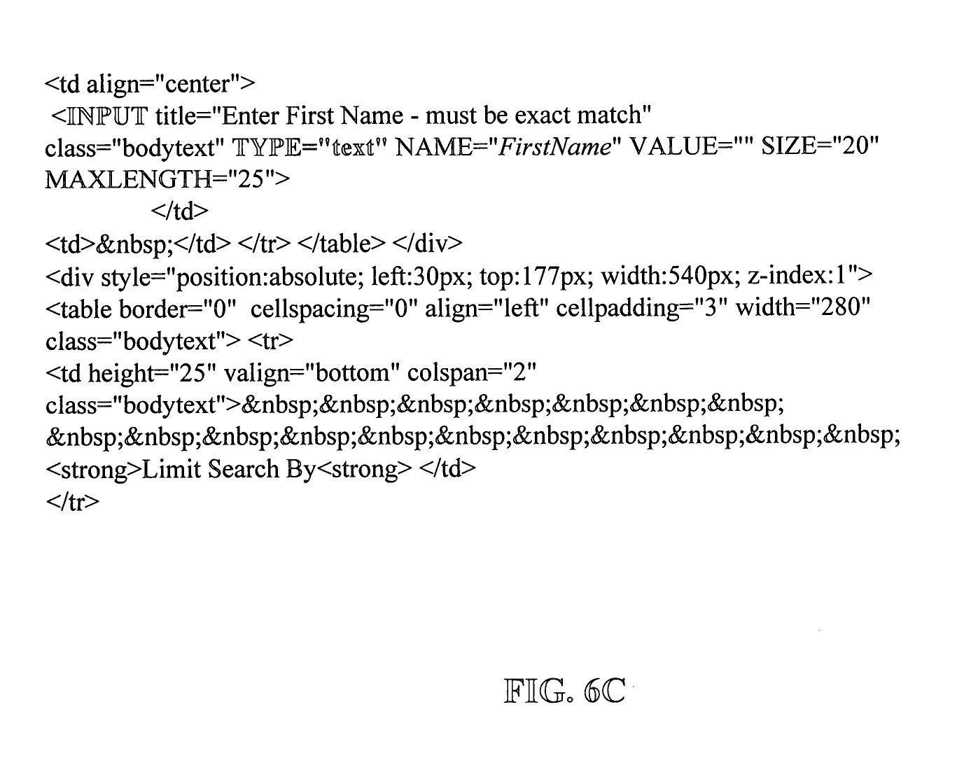

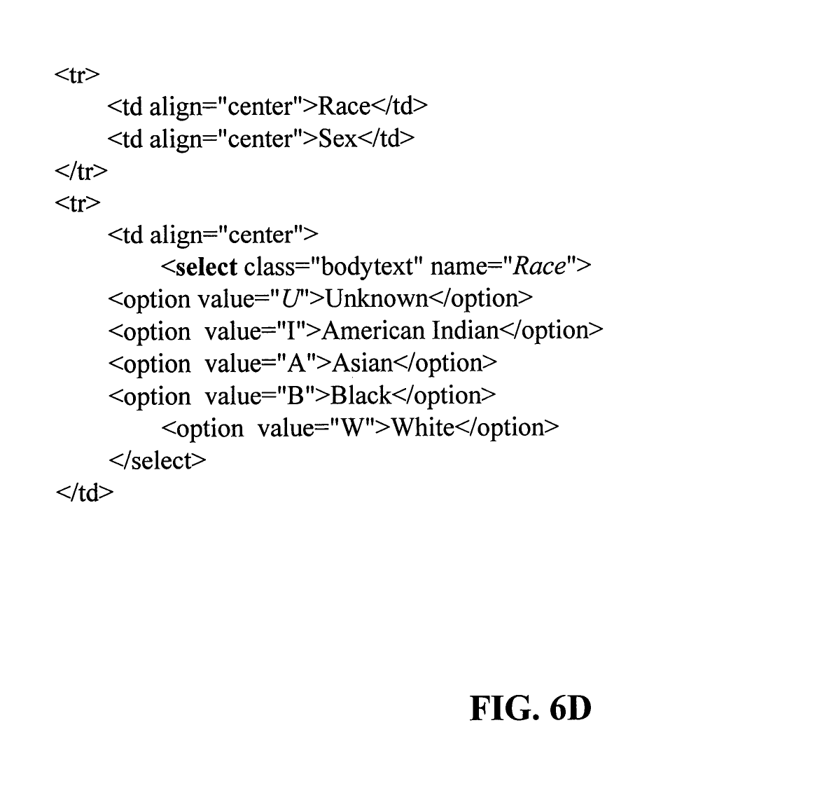

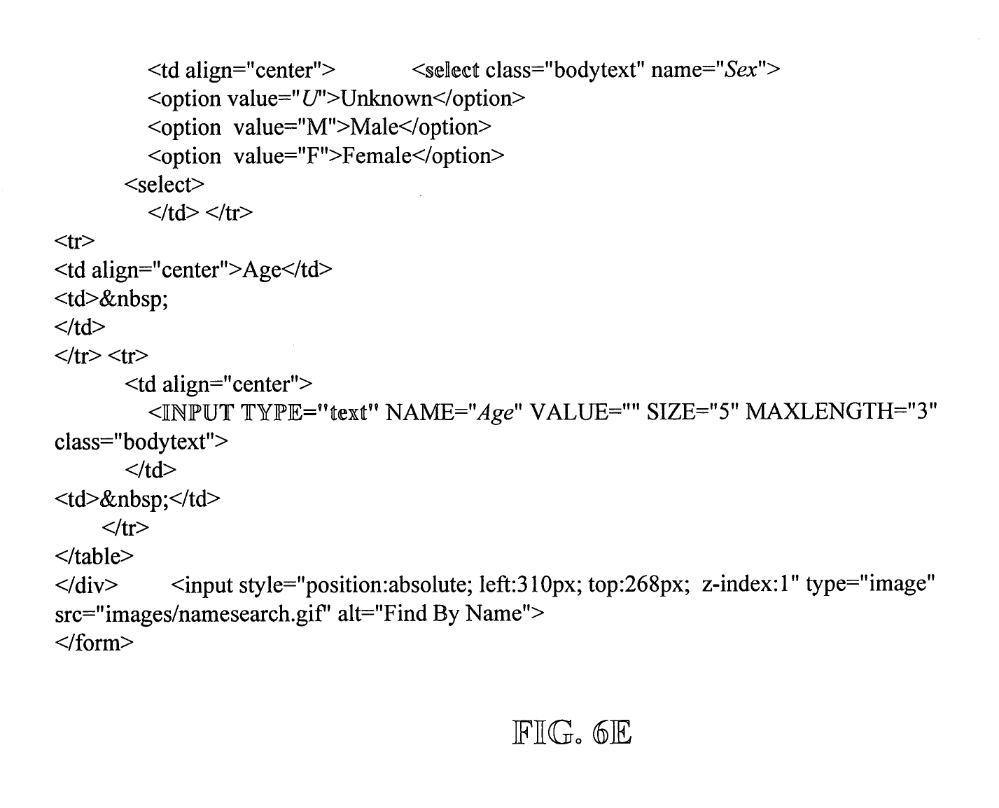

FIGS. 5 and 6 provide marked up HTML web forms where each web form provides at least one user search interface to a web site. The marking up illustrates some of the principles of the analysis of user search interfaces. Thus, FIG. 1A provides a mark up of a web form from Yellow Pages (Switchboard), currently available at http://www.switchboard.com/bin/cgiqa.dll. FIG. 2 provides a mark up of a web form from Federal Bureau of Prisons, currently available at http://www.bop.gov/iloc2/LocateInmate.jsp In FIGS. 5 and 6 the HTML tags that represent useable form and/or fields data are in bold, the fields names and data are in italic, the field description
a) Text of search field as it appears to the user in the browser (field description)—single underline.
b) Additional Text of search field that signals that it is a required field as it appears to the user in the browser (field description—required field)—double underline.
c) HTML tags that represents usable form/fields data (e.g. form tags, form input type)
d) fields names and data—e.g. form action, form method, “name” fields, and “value” fields, where the “value” field can denote default values and/or acceptable values. In some embodiments, the field names get embedded in a formulated query sent to the web site.

Results of the analysis are stored in the User Search Interface Database 110. In some embodiments, the User Search Interface Database 110 resides at least in part in a traditional database. In some embodiments, the User Search Interface Database 110 resides in one or more files stored on disk, including binary files such as “xls” (Excel) files, xml files, flat files, etc. Alternatively, the User Search Interface Database 110 resides in memory, including memory and/or persistent storage.

Thus, according to some embodiments the populating and/or maintaining of the database 110 including parsing of a plurality of web forms. After parsing a web form, certain data items including but not limiting to a target URL, an access method type, a search field name, default search field data, a visual presentation parameter of a search field (e.g. hidden, text, select), a textual description of a search field, and a requirement status of a field are extracted.

In some embodiments, the population of the user search interface database is directed towards obtaining representations of web sites according to a pre-determined subject or theme. Thus, optionally a predetermined list of desired search fields and optional synonyms for each search field is provided, and representations of accessed user search interfaces are added if the user search interface includes one of the predetermined search fields.

Optionally, the user search interface analyzer 108 is adapted to identify semantic meaning of a field of a user search interface for at least one source. Thus, it will be appreciated, for example, that “Last Name,” “Family Name,” and “Surname” provided essentially the same semantic meaning. In one exemplary implementation, the user search interface analyzer 108 has access to a synonyms database.

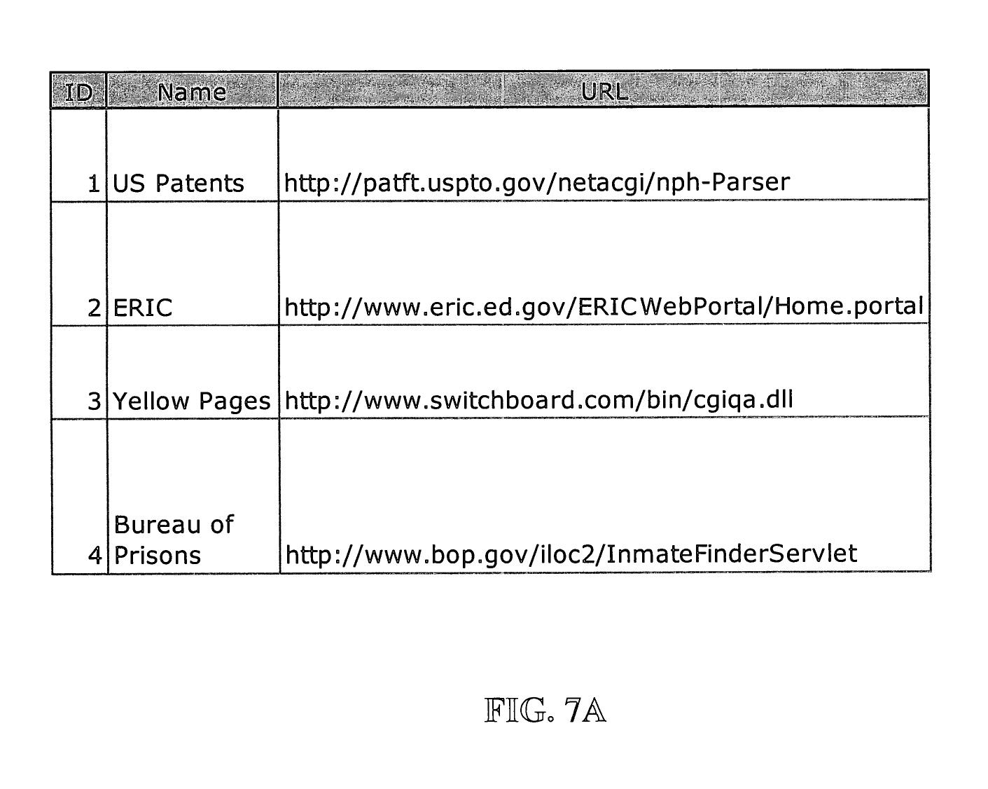

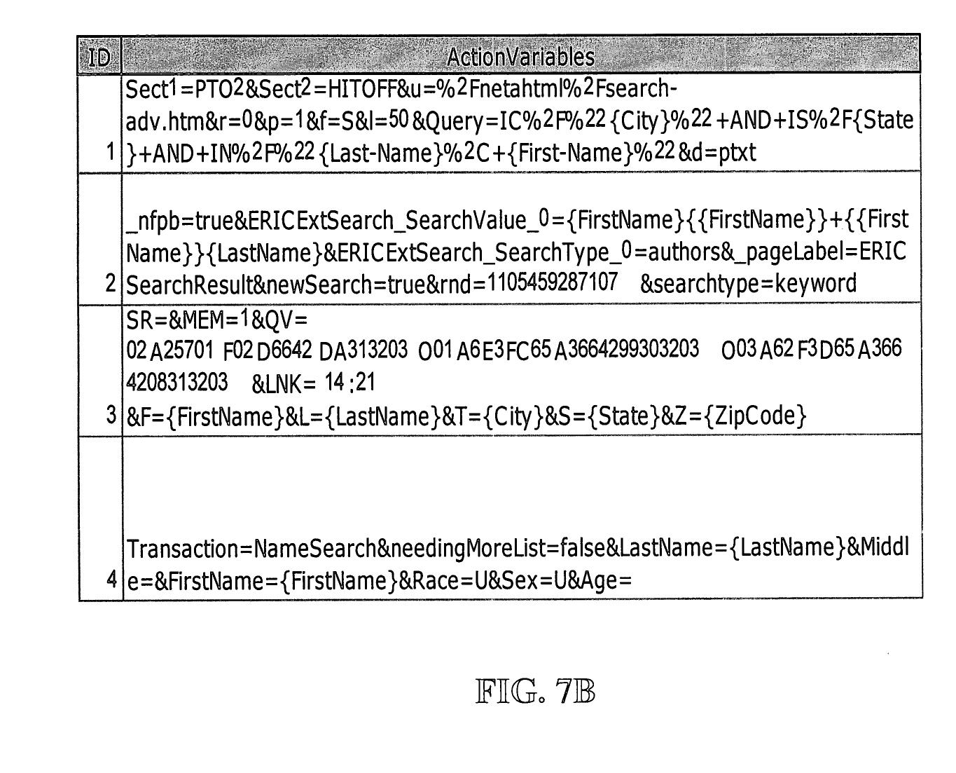

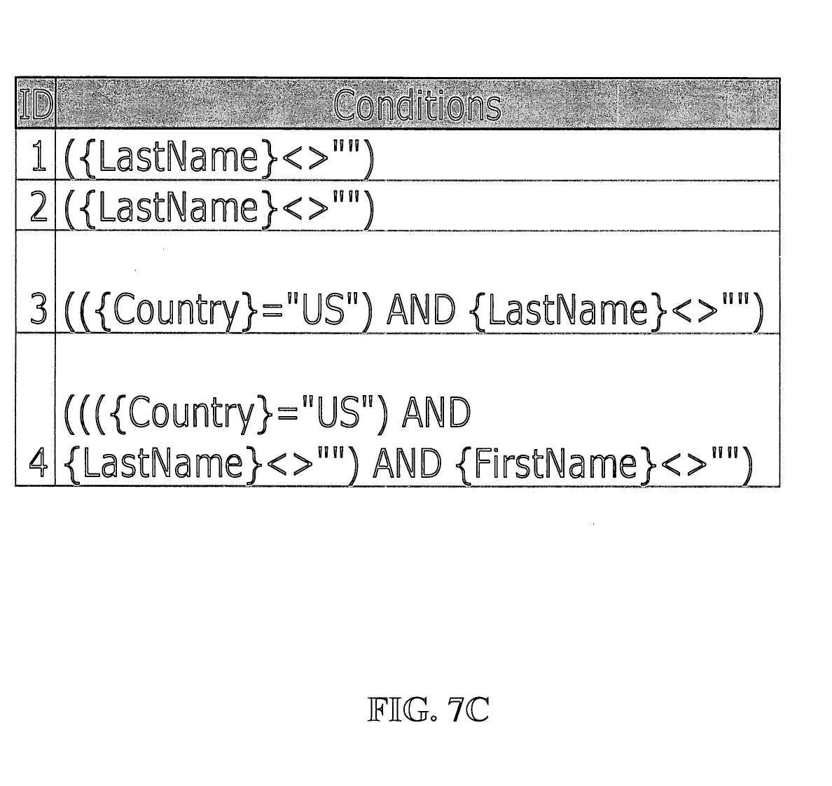

FIG. 7 provides some exemplary database entries from an exemplary User Search Interface Database 110 including a representation of at least one user search interface for each web site. The four relevant web sites of FIG. 7 are the US Patents Web Site, ERIC (Education Resources Information Center—see “Advanced Search”), the Yellow Pages, and the Bureau of Prisons. seen in FIG. 7B, for the yellow pages web site, the semantic meaning of the searchable fields are “FirstName”, “LastName”, “City” and “State.” Although these specific words are not explicitly sent to in a query to the Yellow Pages Web Site, the semantic meaning of each field is quite clear. The “ActionVariables” column in FIG. 7B thus indicates a template for a string which is a substring of a URL to be sent to the “Yellow Pages” web site.

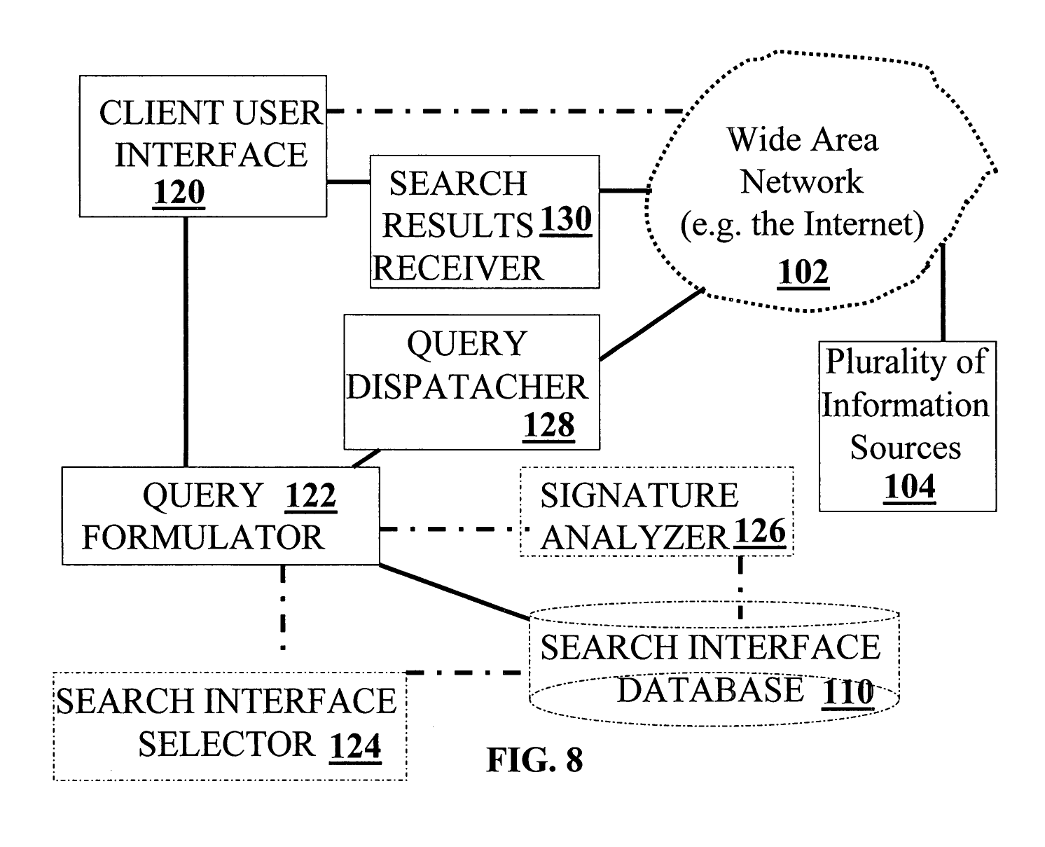

Once the User Search Interface Database 110 is appropriately populated, the User Search Interface Database 110 can be accessed in order to broadcast structured search queries to a plurality of web sites. FIG. 8 provides a schematic diagram of an exemplary system for broadcasting structured queries.

In different embodiments, the system of FIG. 8 is operative to implement any method disclosed herein.

In one example, the client user interface 120 receives a user search query including a plurality of search terms such as {“John”,“Smith”,“Houston”,“Texas”,“77009”}. In some embodiments, a plurality of formulated queries are derived from a single user search query, each query formulated appropriately for the destination website. In some embodiments, a single search query is received via a local machine interface, obviating the need for the user to interact with a plurality of user interfaces in order to send formulated queries to a plurality of web sites. In some embodiments, one or more search queries or one or more plurality of search terms are received through a web interface, including but not limited to HTML interfaces, flash interfaces and applets.

After receiving the plurality of search terms, the Query Formulator 120 retrieves from the User Search Interface Database 110 the representation of at least a part of the user search interface for the “Yellow Pages” web site. Furthermore, the Query Formulator 120 formulates a query such that “John” corresponds to the “First Name” field of the “ActionVariables” column (see the “ActionVariables” string in FIG. 5B, second column, “id” field 3), “Smith” corresponds to the “LastName” field of the “ActionVariables,” “Houston” corresponds to the “City” field of the “Action Variables” string, “Texas” corresponds to the “State” field of the “Action Variables” string and “77009” corresponds to the “ZipCode” field of the “ActionVariables” string. In some embodiments, the Query Formulator 122 can thus be said to use data indicative of the semantic meaning of one or more of the search terms among the plurality of search terms received from the client user interface 120.

It is noted that the example of the previous discussed formulating a query for one specific web site, though it is understand that embodiments of the present invention provide Query Formulators 122 operative to formulate a query for a plurality of web sites.

As used herein, “a directive to search a web site” is a directive sent to the web site to provide information identifying one or more text documents satisfying the search criteria, e.g. a link and/or at least a portion of the text document itself. It is noted that many web sites do not store actual text documents but rather dynamically generate these documents upon request, and thus it will be appreciated that a “directive to search a web site” does not require actual search of actual text documents, but that it suffices that the directive instructs the web site to provide text documents satisfying the search criteria encoded in the search query.

Furthermore, it is noted that the web site need not to be located at a single physical location in the Internet, and can be, for example, a distributed web site at a plurality of location on the Internet.

The semantic correspondence between search terms received through the client user interface 120 and the appropriate field can be established according to a number of ways. In one specific example, the client user interface 120 is operative to specifically receive information indicative of the semantic meaning of each field together with the search terms. This is the method used by user search interfaces from aforementioned examples, wherein the user interface provides field information for each search term to be received.

Alternatively, at least some of this information related to the correspondence between search terms received through the client user interface 120 and the appropriate field to which one or more search terms corresponds can be derived in part using information not explicitly received from the client user interface 120. In one example, the query formulator is instructed that five digit numbers are Zip code, that “John” is likely to be a first name, etc.

As used herein, a “signature” of a plurality of search terms or a “signature” of a user search interface or a “signature” of a search query or formulated search query includes a plurality of search terms wherein each search is associated with a particular search field or text field. In some embodiments, search term in a signature has a particular semantic meaning. It is noted that in some embodiments, a signature is insensitive to the order in which the search terms are presented. Alternatively, in some embodiments, the signature is indeed sensitive to the order in which the search terms are presented.

Thus, consider one example related to a directory of people, where the search query includes: “John” as a first name, “von Hippel” as a last name, “02135” as a zip code, “Brighton” as a city, and “Massachusetts” as a “state.” One representation of the signature of this search query is {First Name, Last Name, Zip Code, City, State}.

This signature has a plurality of subsignatures. As used herein, a subsignature is a signature that is a subset of a signature. In some embodiments, a signature is a subsignature of itself. Alternatively, a subsignature is a “smaller subsignature” wherein at least one term of the subsignature is absent.

Thus, for the signature {First Name, Last Name, Zip Code, City, State}, exemplary subsignatures include but are not limited to {First Name, Last Name, City}, {Zip Code, City, State}, {Last Name, State}, etc.

In some embodiments, a search query received from a user has a given signature a formulated query has a subsignature of the search query. In one example, the user provides a search query with the signature {First Name, Last Name, Zip Code, City, State}. A first information provides the user search interface {First Name, Last Name, City} while a second web site provides the user search interface {Last Name, State}. Thus, in this example the first web site is sent a formulated query with a first subsignature, namely {First Name, Last Name, City}, while the second web site is sent a formulated query with a second subsignature {Last Name, State}. In some embodiments, the first web site and/or the second web site are sent a formulated query with a “smaller subsignature” of the signature of the received search query.

The first and second subsignature and/or smaller subsignature can differ according to any appropriate properties. According to some signatures the first and second subsignature differs by a syntactic property. One example is {First Name, Zip Code} and {First Name, Last Name}, where the Zip Code field can receive only numbers and cannot receive letters.

According to some embodiments, the first and second subsignature differs by a semantic property. One example is {First Name, Current Last Name} and {First Name, Former Last Name}. Although “Current Last Name” and “Former Last Name” have the same syntactic definition (e.g. they can receive letters or number, more than one word, etc}, the semantic meaning of these fields, and hence the respective text field of the text document that these fields are operative to search, differs.

As illustrated in FIG. 8, the appropriate signature or subsignature is chosen in accordance with analysis by the Signature Analyzer 126 of one or more signatures, including but not limited to a signature of a received query and a signature of a user search interface of an web site.

It is also noted that in some examples, a given web site is searchable using a plurality of user search interfaces, wherein one user search interface is appropriate for a received search query while another user search interface of the same web site is not appropriate for the received search query. In one example, a given web site provides user search interfaces with the following two signatures: {First Name, Last Name, State} and {First Name, Last Name, Zip Code}. The received query has signature {First Name, Last Name, State}. In this case, the appropriate user search interface, namely the interface with the query {First Name, Last Name, State} is selected as a “template” according to which the formulated query is derived because the signature of the other user search interface include “Zip Code” which is absent from the signature of the received search query.

Thus, according to some embodiments, the formulated query is derived according to a user search interface selected from a plurality of user search interfaces. As illustrated in FIG. 8, the appropriate user search interface is chosen by a Search Interface Selector 124.

There are a number of criteria according to which an appropriate user search interface may be selected.

According to some embodiments, the user search interface from the plurality of user search interfaces has a signature that best matches the received search query. One exemplary “best matching” of a received search query is a maximal sub-signature defined as the sub-signature with the maximum number of fields. It is recognized that sometimes the “maximal sub-signature” is not necessarily unique, and in some embodiments, an optional secondary set of criteria are applied to select a user search interface from the plurality of user search interfaces.

It is noted that the selecting of a particular user search interface from a plurality of user search interfaces according to which a formulated query is to be derived for a particular web site can include analyzing a number of parameters of user search interfaces and/or the received search query. Exemplary signature parameters include but are not limited to syntactic signature properties, semantic signature properties, and a number of fields in a signature.

Many of the text documents provided by the web sites include a document body and optional labeling text. The optional labeling text is text associated with the document body that is presented separately or in a different manner from the document body. In some embodiments, the labeling text is presented in a different window from the document body, or the labeling text labels a window in which the document body is presented and is not considered an integral part of the text document and/or the text document body. Exemplary labeling text includes but is not limited to meta-tags, document title, email subject field, and email to and/or from fields.

Embodiments of the present invention provide for the deriving of formulated queries associated with a plurality of search terms where each of at least two of the search terms is operative to search a different field from the document body of text documents provided by a respective web site.

Once the queries are formulated by the query formulator 122, the query dispatcher 128 sends the formulated queries through the wide area network 130 to the plurality of web sites. Optionally, some or all of the formulated queries are sent substantially simultaneously. In some embodiments, the formulated queries are sent immediately after formulation by the query formulation 122.

After the queries are sent, results are received by the search results receiver 130. optionally, the results are visually presented to the user. In some embodiments, the search results are presented as a webpage. Alternatively or additionally, the search results are stored in persistent storage on a client machine.

It is noted that in certain embodiments, a single ‘search term’ includes one or more words.

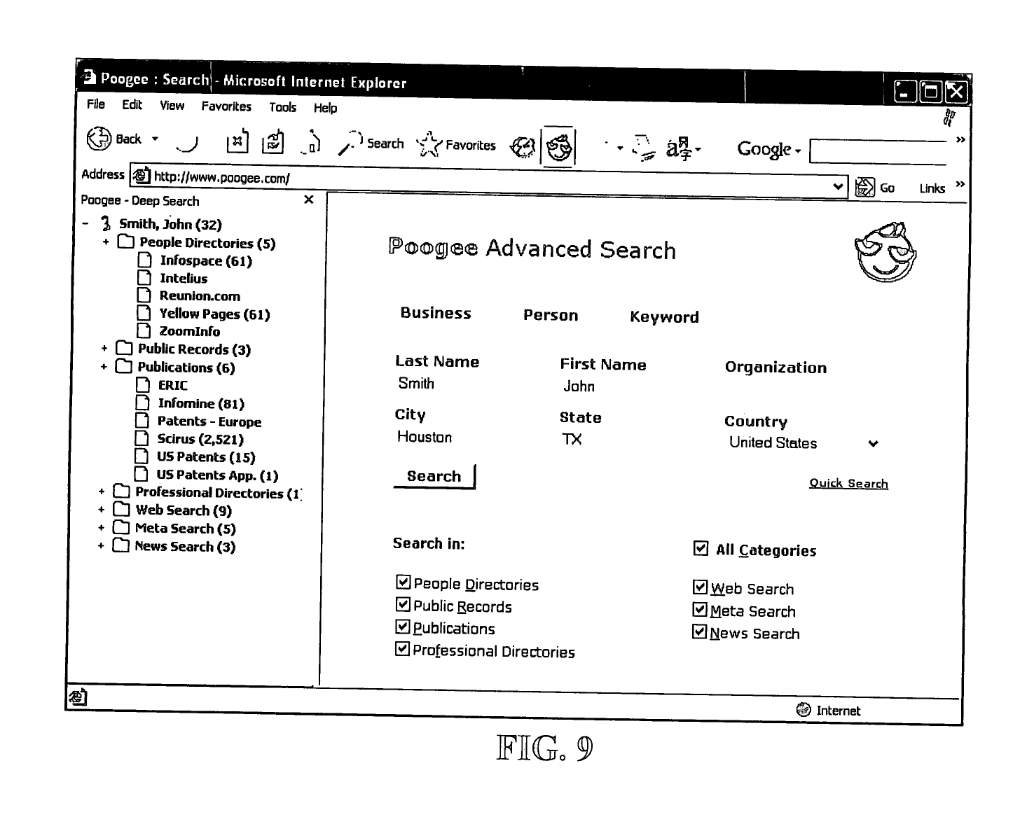

FIG. 9 provides an exemplary client user interface 120 according to some embodiments of the present invention.

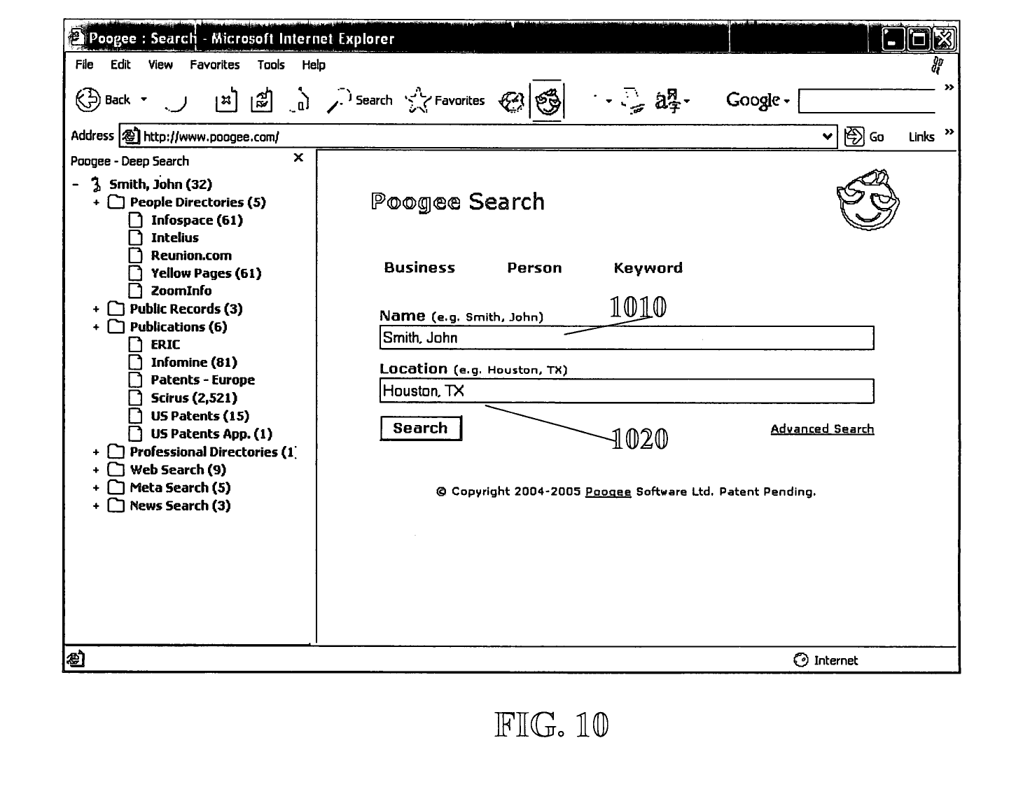

FIG. 10 provides an exemplary client user interface 120 according to some embodiments of the present invention. As illustrated in FIG. 10, the user interface 120 is operative to receive strings in text boxes 1010 and 1020, and to identify within at least one received string a plurality of search terms. In the case of 1010, the search terms identified are “John” and “Smith,” and in the case of 1020 the search terms identified are “Houston” and “TX.” Two or more of these identified search terms collectively comprise the user search query. Furthermore, as illustrated in FIG. 10, the user interface 120 is operative to identify respective text field types within the string, and to associate each search term with the appropriate text field type. For the example of FIG. 10, the system of FIG. 8 recognizes that “Smith” is implicitly associated with “Last Name”, “John” is implicitly associated with “First Name”, “Houston” is implicitly associated with “City”, “Texas” is implicitly associated with “State.”

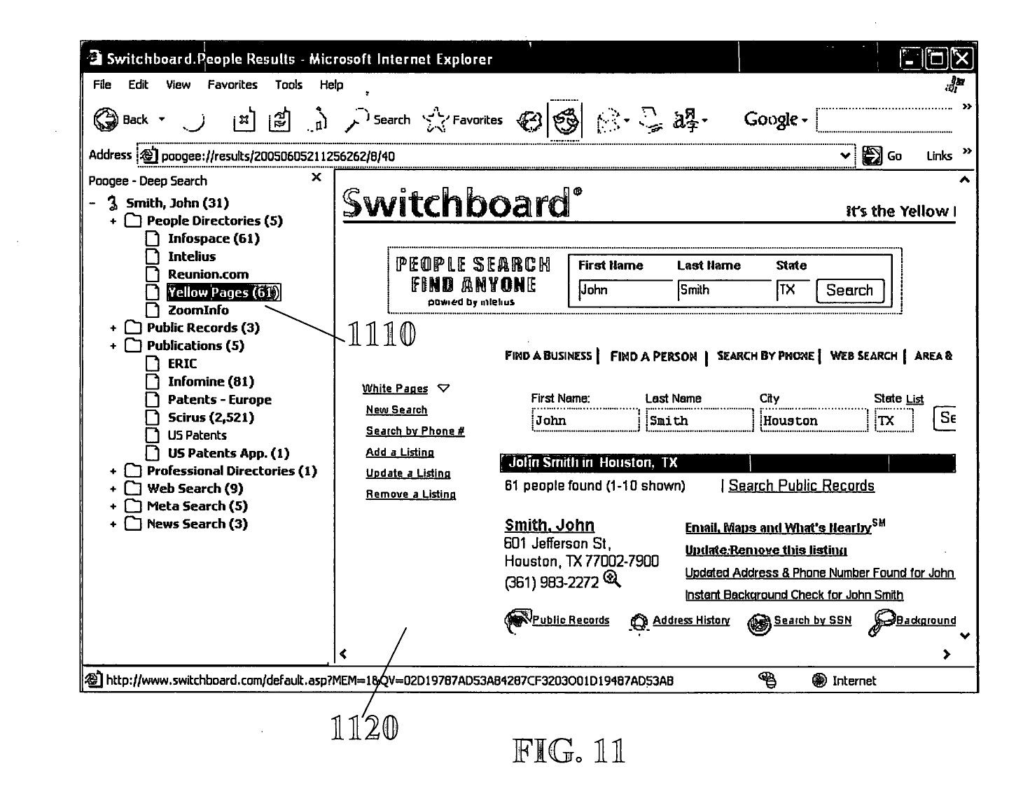

FIG. 11 provides a screenshot of an interface for receiving search results (120, 130) according to some embodiments of the present invention. It is noted that interface provides 1110 for selection of search results from specific web sites from a plurality of web sites. The specific web sites are categorized. Upon selecting the desired web site, the actual text documents provided by the web sites, or portions thereof, are available in the results window 1120.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1) A method of searching web sites, each web site providing a user search interface array including at least one user search interface for accessing text documents, each text document including a document body and optional labeling text, the method comprising:
a) maintaining a database including at least a partial representation of the respective user search interface array for each web site;
b) receiving at least one user search query associated with a plurality of search terms;
c) for each web site, deriving from said respective representation and from said received user search query a formulated search query encoding directives to search the web site such that each said search term matches a value of a different respective text field of the text documents;
d) broadcasting a plurality of said formulated search queries to a plurality of web sites; and
e) receiving search results of said broadcast queries.

2) The method of claim 1 wherein at least one said formulated query encodes a directive to search at least one web site such that each said search term matches a value of a different respective text field within the document body of the text documents.

3) The method of claim 1 wherein said receiving of said search results includes receiving at least one identifier for accessing a respective text document, the method further comprising:
f) presenting to a user a menu of at least one said identifier.

4) The method of claim 1 wherein said receiving of said search results includes receiving at least one text document satisfying search criteria of a said formulated query from at least one web site.

5) The method of claim 1 wherein each said search term is associated with a different respective text field type.

6) The method of claim 5 wherein said receiving of said plurality of search terms includes:
i) receiving a string; and
ii) identifying within said string a plurality of said search terms, each said search term associated with a different text field type.

7) The method of claim 5 wherein said receiving of said user search query includes presenting a user search field interface for receiving and/or presenting a plurality of said text field type identifiers.

8) The method of claim 7 wherein said user search field interface is configured for selecting a said text field type identifiers from a plurality of said text field type identifiers.

9) The method of claim 5 wherein said formulated query encodes a directive to search the web site such that each said respective search term matches a value of a text field having a type that is semantically equivalent to said text field type associated with said respective search term.

10) The method of claim 1 wherein for at least one web site, said formulated search query is substantially identical to a query generatable using a user search interface of the web site.

11) The method of claim 1 wherein said matching of said value of text field is selected from the group consisting of exact match, regular expression match, a synonym match, an approximate string match, a mapping match, a prefix match.

12) The method of claim 1 wherein said formulated queries are sent substantially simultaneously.

13) The method of claim 1 wherein a single said search query is received, and at least two said formulated queries are derived from said received single search query.

14) The method of claim 13 wherein said single said search query is received via a single interface.

15) The method of claim I wherein said at least one search query is received through a web interface.

16) The method of claim 1 further comprising:
e) presenting said search results as a webpage.

17) The method of claim 1 wherein said maintaining of said database includes:
i) providing a predetermined list of desired search fields;
ii) accessing a plurality of user search interfaces associated with a plurality of candidate web sties;
iii) adding a representation of said accessed user search interface to said database if said accessed search interface provides access to a web site with at least one said desired search field.

18) The method of claim 1 wherein said maintaining of said database includes parsing a plurality of web forms.

19) The method of claim 1 wherein said maintaining of said database includes:
i) accessing a plurality of user search interfaces associated with a plurality of candidate web sites;
ii) extracting from said accessed user search interface at least one data item selected from the group consisting of a target URL, an access method type, a search field name, default search field data, a visual presentation parameter of a search field, a textual description of a search field, and a requirement status of a field.

20) The method of claim 1 wherein said maintaining of said database includes identification of a semantic meaning of a field of a search interface for at least web site.

21) The method of claim 1 wherein said deriving of a said formulated query includes determining a signature of a said received search query, and for a first web site a first said formulated query is created according to a first subsignature of said received search query signature, and for a web site a second said formulated query is created according to a second subsignature of said received search query signature, wherein said first subsignature differs from said second subsignature.

22) The method of claim 21 wherein said first subsignature differs from said second subsignature according to syntactic properties.

23) The method of claim 21 wherein said first subsignature includes a first number of search fields, second said subsignature includes a second number of fields, and said first number differs from said second number.

24) The method of claim 21 wherein said first subsignature differs from said second subsignature according to semantic properties.

25) The method of claim 1 wherein for at least one web site said representation includes a representation of a plurality of search interfaces, and said deriving of said formulated query includes selecting a search interface appropriate for a said received search query from said representation of said plurality of search interfaces.

26) The method of claim 25 wherein said selecting includes locating a user search interface from said plurality of user search interfaces with a signature that best matches a signature of a said received search query.

27) The method of claim 26 wherein said best match is an exact match of said received search query.

28) The method of claim 26 wherein said best match is a maximal sub-signature of said received search query.

29) The method of claim 25 wherein said selecting of said appropriate search interface includes analyzing at least one signature parameter selected from the group consisting of a syntactic property of a signature, a semantic property of a signature and a number of fields in a signature.

30) The method of claim 1 wherein said stage of sending a plurality of formulated queries includes generating at least one HTTP request.

31) A system for searching web sites, each web site providing a search interface array including at least one user search interface for accessing text documents, each text document including a document body and optional labeling text, the system comprising:
a) a database including at least a partial representation of the respective user search interface array for each web site;
b) a search query input for receiving at least one user search query associated with a plurality of search terms;
c) a formulated query creator for deriving from said respective representation and from said user search query a formulated search query encoding directives to search the web site such that each said search term matches a value of a different respective text field of the text documents;
d) a formulated query dispatcher for broadcasting a plurality of said formulated search queries to a plurality of web sites; and
e) a search results receiver for receiving search results of said broadcast queries.

32) The system of claim 31 wherein said query creator is operative to derive at least one said formulated query encoding a directive to search at least one web site such that each said search term matches a value of a different respective text field within the document body of the text documents.

33) The system of claim 31 wherein said search results receiver is operative to present a user menu of at least one received receive identifier for accessing a respective text document.

34) The system of claim 31 wherein said search results receiver is operative to receive at least one text document satisfying search criteria of a said formulated query from at least one web site.

35) The system of claim 31 wherein each said search term is associated with a different respective text field type.

36) The system of claim 35 wherein said search query input is further operative to receive a string and identify within said string a plurality of said search terms, each said search term associated with a different text field type.

37) The system of claim 36 further comprising: said receiving of said user search query includes presenting a user search field interface for receiving and/or presenting a plurality of said text field type identifiers.

38) The system of claim 37 further comprising:
f) a user input interface associated with said user input,
said user input interface operative to select a said text field type identify from a plurality of said text field type identifiers.

39) The system of claim 35 wherein said formulated query encodes a directive to search the web site such that each said respective search term matches a value of a text field having a type that is semantically equivalent to said text field type associated with said respective search term.

40) The method of claim 31 wherein for at least one web site, said formulated creator is operative to create a search query that is substantially identical to a query generatable using a user search interface of the web site.

42) The system of claim 31 wherein said matching of said value of text field is selected from the group consisting of exact match, regular expression match, a synonym match, an approximate string match, a mapping match, a prefix match.

43) The system of claim 31 wherein said formulated query dispatcher is operative to substantially simultaneously send said formulated queries to the respective web sites.

44) The system of claim 31 further comprising:
f) a signature analyzer, for analyzing at least one signature selected from the group consisting of a signature of said received search query and at least one user search interface selected from the user search interface array of a web site,
wherein said formulated query creator is operative to create at least one said formulated query in accordance with results of said signature analysis.

44) The system of claim 31 wherein at least one said description of the respective search interface array includes for at least one web site a description of a plurality of user search interfaces, further comprising:
f) a search engine interface selector for selecting an appropriate user search interface from said plurality of search interfaces.

45) The system of claim 31 further comprising:
g) a signature analyzer, for analyzing at least one signature of a user search interface among said plurality of search interfaces,
wherein said selection of said appropriate search interface is effected in accordance with results from said signature analysis.

46) The system of claim 31 further comprising:
f) at least one interface for providing access to said received search results.

47) A computer readable storage medium having computer readable code embodied in said computer readable storage medium, said computer readable code for searching web sites, each web site providing a search interface array including at least one user search interface for accessing text documents, each text document including a document body and optional labeling text, said computer readable code comprising instructions for:
a) maintaining a database including at least a partial representation of the respective user search interface array for each web site;
b) receiving at least one user search query associated with a plurality of search terms;
c) for each web site, deriving from said respective representation and from said user search query a formulated search query encoding directives to
search the web site such that each said search term matches a value of a different respective text field of the text documents;
d) broadcasting a plurality of said formulated search queries to a plurality of web sites; and
e) receiving search results of said broadcast queries.
